(19) United States
(12) Patent Application Publication
(10) Pub. No.: US 2008/0033949 A1
(43) Pub. Date: Feb. 7, 2008

(54) ELECTRONIC APPARATUS AND METHOD THEREFOR

(75) Inventors: Xiao-Guang Li, Shenzhen City (CN); Zai-An Pan, Shenzhen City (CN); Kuan-Hong Hsieh, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/832,663

(22) Filed: Aug. 2, 2007

(30) Foreign Application Priority Data
Aug. 7, 2006 (CN) 200610200780.X

(51) Int. Cl. G06F 7/08

(52) U.S. Cl. 707/7

(57) ABSTRACT

An electronic apparatus is provided. The apparatus includes an interface for connecting to a host; an input unit; a display unit; a storage unit for storing files, attributes associated with the files, a file list which stores file records each of which corresponds to one of the files and stores the attributes of the corresponding file; a micro control unit (MCU), includes a list control module for updating the file list according to the sort field; an acquiring module for acquiring the file list; a list presenting module for controlling the display unit to display the acquired file list, and for generating a file selection signal according to a file selection operation through the input unit; an executing module configured for reading a corresponding file from the storage unit to be executed on the host according to the file selection signal.

### BACKGROUND

1. Technical Field

The present invention relates to an electronic apparatus, and particularly to an electronic apparatus and a method capable of easily finding files.

2. General Background

Data exchange between digital devices (e.g., computers, digital cameras, personal digital assistants (PDA), smart phones) are very common. However, the digital devices may not be able to directly connect to each other. Thus, removable or external storage devices such as flash memory devices and removable hard disk are popular means used for data exchanging between digital devices. Users often need to create or edit a file on one device, and transfer it to another through removable storage device as mentioned above. If there are too many files in the removable storage device it would be difficult to look up a certain file because the access time of external devices are generally slow. Additionally, multiple mouse click operations may need to be performed to access a file stored on the external device. For example, if a file “m.xls” is stored in a path “x:\a\c\f\e\m.xls”, at least a 4 click operation need to be performed to access the “e” directory where the file is stored, further, if there are too many files or folders in each of the folders a, c, f, and e in the path, users need to search through or have previous knowledge of the direct path to the file.

Some operation systems, e.g., Microsoft Windows XP, provide file sorting function and file searching function for users to find files or file folders, but the file sorting function can sort the files only under one directory and is not customizable; and the file searching function could add operations of inputting searching keywords through keyboard before search, further, the searching process consumes lots of system resources and time if there are too many files in the removable storage device.

What is needed, therefore, is an electronic apparatus and method therefor, through which users can sort the files stored in the apparatus in a proper order, so as to find out files with ease.

### SUMMARY

An electronic apparatus is provided. The apparatus includes an interface for connecting to a host; an input unit; a display unit; a storage unit for storing files, attributes associated with the files, a file list which stores file records each of which corresponds to one of the files and stores the attributes of the corresponding file, the file records are sorted in a sort field which is selected from one of the attributes; a micro control unit (MCU), includes a list control module for updating the file list according to the sort field; an acquiring module for acquiring the file list; a list presenting module for controlling the display unit to display the acquired file list, and for generating a file selection signal according to a file selection operation through the input unit; an executing module configured for reading a corresponding file from the storage unit to be executed on the host according to the file selection signal.

A method for selecting files from an electronic apparatus is further provided. The apparatus stores files, attributes associated with the files, and a file list. The file list stores a predetermined number of file records each of which corresponds to one of the files and stores a predetermined number of the attributes associated with the corresponding file. The file records are sorted in a sort field which is selected from one of the attributes, the method includes: acquiring the file list; displaying the acquired file list in a display unit of the electronic apparatus; generating a file selection signal according to a file selection operation; reading a corresponding file according to the file selection signal, sending the read file to the host; executing the read file on the host; and updating the file list.

Other advantages and novel features will be drawn from the following detailed description with reference to the attached drawing.

### BRIEF DESCRIPTION OF THE DRAWINGS

FIG. 1 is a block diagram of a hardware infrastructure of an electronic apparatus in accordance with a preferred embodiment;

FIG. 2 is a schematic diagram of an appearance of the electronic apparatus of FIG. 1;

FIG. 3 is a schematic diagram illustrating a sort field selection interface;

FIG. 4 is a flowchart of a method for selecting files by utilizing the electronic apparatus of FIG. 1 with a preferred embodiment;

FIG. 5 is a block diagram of a hardware infrastructure of the apparatus with an alternative embodiment; and

FIG. 6 is a flowchart of a method for selecting files by utilizing the electronic apparatus of FIG. 5 with an alternative embodiment.

### DETAILED DESCRIPTION OF THE EMBODIMENT

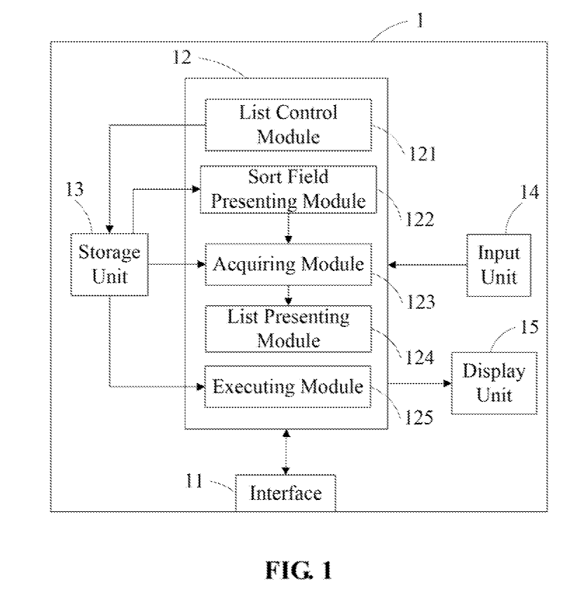

FIG. 1 is a block diagram of a hardware infrastructure of an electronic apparatus in accordance with a preferred embodiment of the present invention. The apparatus 1 can be storage devices, such as flash memory drives and removable hard disk drives. The apparatus 1 includes an interface 11, a micro controlling unit (MCU) 12, a storage unit 13, an input unit 14, and a display unit 15. The interface 11 is configured for connecting to a host (not shown). The host could be a computer that is capable of controlling the apparatus 1. For example, the apparatus 1 is a USB removable hard disk, while the USB removable hard disk connects to a USB port of the computer, the computer can operate the USB removable hard disk, e.g., read, write or delete files stored in the USB removable hard disk. The input unit 14 is configured for receiving operational inputs from users.

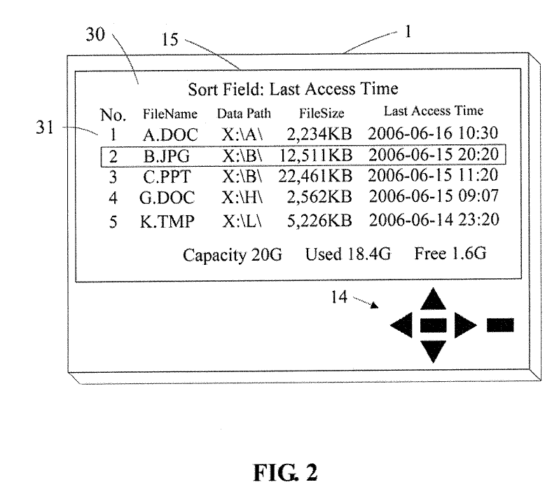

The storage unit 13 is configured for storing files and attributes associated with the files. The attributes mainly include a filename, data path, file size, and timestamps, such as creation time, last modification time, and last access time. Each of the attributes can be used as a sort field for sorting the files. Accordingly, the files may have one or more sorted orders corresponding to the sort fields. The storage unit 13 further stores a plurality of file lists, each of which corresponds to one of the sorted orders and stores a predetermined number of file records sorted by a corresponding sort field. Each of the file records corresponds to one of the files and stores the attributes associated with the corresponding file (see file records 31 in FIG. 2). That is, the file records of each of the file lists are sorted according to a distinct sort field (namely, a distinct attribute). For example, file records of a file list 30 (see FIG. 2) are sorted according to the last access time. Typically, files accessed most recently are listed at a top of the file list 30, whereas, files having the least recent accessed time are listed at a bottom of the file list 30. For example, in the embodiment as shown in FIG. 2, the file record No. 1 with a most recent access time is listed ahead of file No. 2 with a lesser accessed time of file No. 1.

The MCU 12 includes a list control module 121, a sort field presenting module 122, an acquiring module 123, a list presenting module 124, and an executing module 125. The list control module 121 is configured for updating orders of the file records of the file lists according to the corresponding sort fields in response to changes of the corresponding attributes. For example, in the file list 30, if a file “C.PPT” is recently accessed by a user, namely where the attribute “last access time” of the file “C.PPT” is changed and the file “C.PPT” is accordingly the most recently accessed file in the storage unit 13, the list control module 121 updates the order of the file records of the file list 30. As a consequence, a file record corresponds to the file “C.PPT” becomes the first file record in the file list 30.

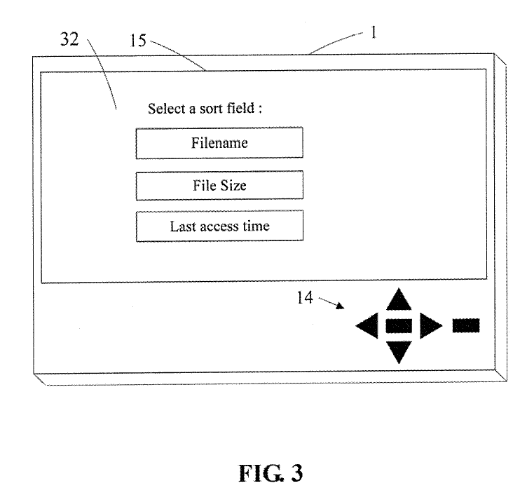

The sort field presenting module 122 is configured for controlling the display unit 15 to display a sort field selection interface 32 such as that shown in FIG. 3. The sort field selection interface 32 provides the sort fields of the file lists for selection. Accordingly, users can perform a sort field selection operation to select one of the presented sort fields through the input unit 14. The sort field presenting module 122 further generates a sort field selection signal according to the sort field selection operation. The acquiring module 123 is configured for acquiring a corresponding file list according to the sort field selection signal. The list presenting module 124 is configured for controlling the display unit 15 to display the acquired file list, thus, users can perform a file selection operation to select one of the files in the displayed file list through the input unit 14. The list presenting module 124 further generates a file selection signal according to the file selection operation. The executing module 125 is configured for reading a corresponding file from the storage unit 13 according to the file selection signal and sending the read file to the host. The host executes the read file.

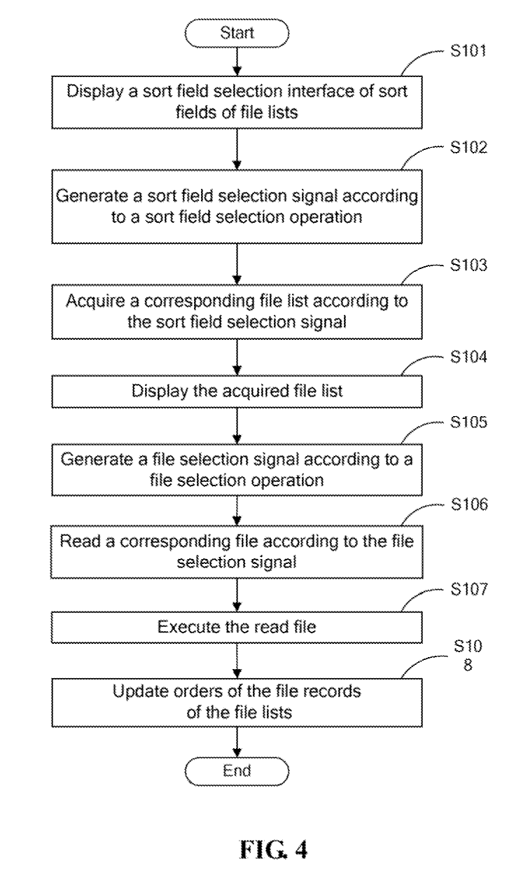

FIG. 4 is a flowchart of a method for selecting files by utilizing the electronic apparatus of FIG. 1 with a preferred embodiment of the present invention.

In step S101, the sort field presenting module 122 controls the display unit 15 to display the sort field selection interface 32.

In step S102, the sort field presenting module 122 generates the sort field selection signal according to the sort field selection operation through the input unit 14.

In step S103, the acquiring module 123 acquires a corresponding file list according to the sort field selection signal.

In step S104, the list presenting module 124 controls the display unit 15 to display the acquired file list.

In step S105, the list presenting module 124 generates a file selection signal according to the file selection operation through the input unit 14.

In step S106, the executing module 125 reads a corresponding file from the storage unit 13 according to the file selection signal, and sends the read file to the host.

In step S107, the host executes the read file.

In step S108, the list control module 121 updates orders of the file records of the file lists according to the corresponding sort fields in response to changes of the attributes.

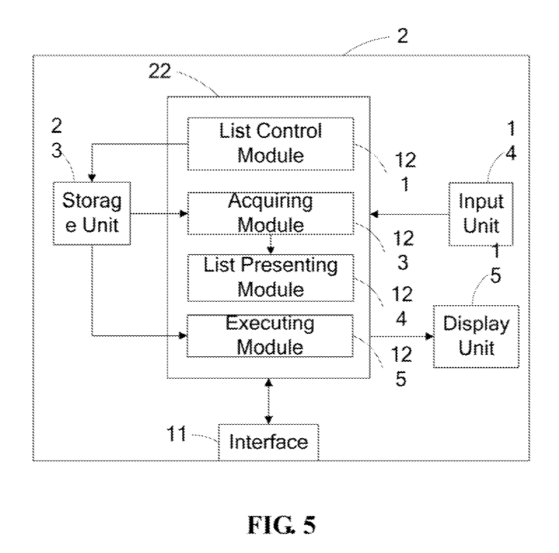

FIG. 5 is a block diagram of hardware infrastructure of an electronic apparatus in accordance with an alternative embodiment of the present invention. Here, like components to those of FIG. 1 have the same reference numerals and therefore the description, configurations, and functions of these like components are omitted. The differences between the preferred embodiment and the alternative embodiment are: in the preferred embodiment, the storage unit 13 stores a plurality of file lists each corresponding to a sort field, and the sort field presenting module 122 controls the display unit 15 to display the sort fields for selection; in the alternative embodiment, a storage unit 23 stores only one file list, the sort field selection operation is unnecessary, so the apparatus 2 does not include the sort field presenting module 122 as the apparatus 1 does. While the apparatus 2 connects to the host, the acquiring module 123 acquires the file list automatically, and the list presenting module 124 presents the acquired file list.

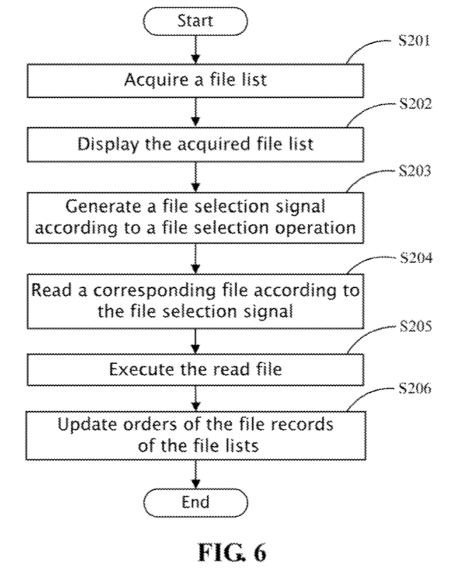

FIG. 6 is a flowchart of a method for selecting files by utilizing the electronic apparatus of FIG. 5 with an alternative embodiment of the present invention.

In step S201, the acquiring module 123 acquires the file list from the storage unit 23.

In step S202, the list presenting module 124 controls the display unit 15 to display the acquired file list.

In step S203, the list presenting module 124 generates a file selection signal according to the file selection operation through the input unit 14.

In step S204, the executing module 125 reads a corresponding file from the storage unit 23 according to the file selection signal, and sends the read file to the host.

In step S205, the host executes the read file.

In step S206, the list control module 121 updates the order of the file records of the file list according to the corresponding sort field in response to changes of the corresponding attribute.

Therefore, by utilizing the apparatus 1 or the apparatus 2, files stored therein are sorted in one or more sorted orders according to attributes associated with the files, accordingly, a file that is, for example, with a largest size, or with a latest timestamp of last accessed, can be easily find, thereby saving file searching time and bringing convenience to the users.

Although the present invention has been specifically described on the basis of preferred embodiments and preferred methods thereof, the invention is not to be construed as being limited thereto. Various changes or modifications may be made to the embodiment and method without departing from the scope and spirit of the invention.

What is claimed is:

1. An electronic apparatus, comprising:
an interface configured for connecting to a host;
an input unit configured for receiving operational inputs;
a display unit;
a storage unit configured for storing files, attributes associated with the files, and a file list, wherein the file list stores a predetermined number of file records each of which corresponds to one of the files and stores a predetermined number of the attributes of the corresponding file, wherein the file records are sorted in a sort field which is selected from one of the attributes; and
a micro control unit (MCU), comprising:
a list control module configured for updating the file list according to the sort field in response to changes of the attribute corresponding to the sort field;
an acquiring module configured for acquiring the file list;
a list presenting module configured for controlling the display unit to display the acquired file list, and for generating a file selection signal according to a file selection operation through the input unit; and
an executing module configured for reading a corresponding file from the storage unit to be executed on the host according to the file selection signal.

2. The apparatus according to claim 1, wherein the attributes comprise at least one item selected from a group comprising: filename; storage path; size; timestamp of creation; timestamp of last modification; and timestamp of last access.

3. An electronic apparatus, comprising:
an interface configured for connecting to a host;
an input unit configured for receiving operational inputs;
a display unit;
a storage unit configured for storing files, attributes associated with the files, and a plurality of file lists, wherein each of the file lists stores a predetermined number of file records each of which corresponds to one of the files and stores a predetermined number of the attributes of the corresponding file, wherein the file records of each of the file lists are sorted in a respective sort field which is selected from one of the attributes; and
a micro control unit (MCU), comprising:
a list control module configured for updating the file lists according to the sort fields in response to changes of the attributes corresponding to the sort fields respectively;
a sort field presenting module configured for controlling the display unit to display the sort fields of the file lists, and for generating a sort field selection signal according to a sort field selection operation through the input unit;
an acquiring module configured for acquiring a corresponding file list according to the sort field selection signal;
a list presenting module configured for controlling the display unit 15 to display the acquired file list, and for generating a file selection signal according to a file selection operation through the input unit; and
an executing module configured for reading a corresponding file from the storage unit to be executed on the host according to the file selection signal.

4. The apparatus according to claim 3, wherein the attributes comprise at least one item selected from a group comprising: filename; storage path; size; timestamp of creation; timestamp of last modification; and timestamp of last access.

5. A method for selecting files from an electronic apparatus, wherein the apparatus stores files, attributes associated with the files, and a plurality of file lists, wherein each of the file lists stores a predetermined number of file records each of which corresponds to one of the files and stores a predetermined number of the attributes associated with the corresponding files, wherein the file records are sorted in a sort field which is selected from one of the attributes, the method comprising:
displaying the sort fields in a display unit of the electronic apparatus while the apparatus connects to a host;
selecting one of the sort fields;
acquiring a corresponding file list according to the selected sort field;
displaying the acquired file list in the display unit;
generating a file selection signal according to a file selection operation;
reading a corresponding file according to the file selection signal, and sending the read file to the host;
executing the read file on the host; and
updating the file lists according to the sort field in response to changes of the attributes corresponding to the sort fields.

6. A method for selecting files from an electronic apparatus, wherein the apparatus stores files, attributes associated with the files, and a file list, wherein the file list stores a predetermined number of file records each of which corresponds to one of the files and stores a predetermined number of the attributes associated with the corresponding files, wherein the file records are sorted in a sort field which is selected from one of the attributes, the method comprising:
acquiring the file list while the apparatus connects to a host;
displaying the acquired file list in a display unit of the electronic apparatus;
generating a file selection signal according to a file selection operation;
reading a corresponding file according to the file selection signal, and sending the read file to the host;
executing the read file on the host; and
updating the file list according to the sort field in response to changes of the attribute corresponding to the sort field.
